(19) United States
(12) Patent Application Publication
(10) Pub. No.: US 2016/0180348 A1
(43) Pub. Date: Jun. 23, 2016

(54) ENTITY REPRESENTATION VIA PERSISTENT COMPUTE OBJECTS

(71) Applicant: Brigham Young University, Provo, UT (US)

(72) Inventor: Phillip J. Windley, Lindon, UT (US)

(21) Appl. No.: 14/975,052

(22) Filed: Dec. 18, 2015

Related U.S. Application Data
(60) Provisional application No. 62/094,248, filed on Dec. 19, 2014.

(51) Int. Cl. G06Q 30/00; G06Q 10/00; G06Q 50/18; H04L 29/08

(52) U.S. Cl. CPC G06Q 30/016; H04L 67/12; G06Q 10/20; G06Q 50/188

(57) ABSTRACT

Systems and methods relating to autonomously establishing mutually acceptable terms for the procurement of goods and/or services on behalf of one or more represented entities. In various embodiments, this may include negotiating the payment amount, timing of payment, and/or method of payment. Persistently available compute objects or just persistent compute objects (PICOs) may operate autonomously on behalf of their owner. PICOs may communicate with other online services and even pay for services in accordance with one or more rules that the owner or other associated entity has set. PICOs may have an identity, storage, an open event network interface, a processor, event channels, and an application program interface (API). For example, a PICO may be a small, special-purpose, online computer. A PICO may be virtualized for scalability. For example, a PICO may be an object (in the object-oriented programming sense) that has persistent storage and is always online.

### RELATED APPLICATIONS

This application claims priority to U.S. Provisional Patent Application No. 62/094,248, titled “Making Payments With Persistent Compute Objects,” filed on Dec. 19, 2014, which is hereby incorporated by reference in its entirety.

### TECHNICAL FIELD

This disclosure relates to the computer systems and network architectures that allow for persistent compute objects to represent and autonomously operate on behalf of represented entities.

### BRIEF DESCRIPTION OF THE DRAWINGS

FIG. 1 illustrates a block diagram of a plurality of persistent compute objects (PICOs) that represent a plurality of entities, according to one embodiment.

FIG. 2 illustrates a block diagram of a network architecture for a PICO space, an entity space, and an intermediate hosting space with a variety of optional hosting possibilities, according to various embodiments.

FIG. 3 illustrates an example of entity-represented autonomous negotiation by a first PICO with another system, according to one embodiment.

FIG. 4 illustrates an ecosystem in which a PICO autonomously represents a vehicle in communication with PICOs autonomously representing two different maintenance shops, according to one embodiment.

FIG. 5 illustrates an example of an ecosystem in which PICOs represent individual vehicles within a fleet that is in turn represented by a fleet PICO, allowing for autonomous fleet-level communications with PICOs representing insurers and maintenance shops.

FIGS. 6A-6C illustrate the transition of ownership of an autonomous PICO representing a vehicle from a manufacturer to a dealer and then to a consumer.

FIG. 7 illustrates a system in which a PICO autonomously represents a lawnmower in communications with PICOs representing manufacturers, a warranty-authorized maintenance shop, and an unauthorized maintenance shop.

FIG. 8 illustrates a neighborhood in which each neighbor is autonomously represented by a PICO, according to one exemplary embodiment.

FIG. 9 illustrates a family in which each family member is autonomously represented by a PICO, according to one exemplary embodiment.

FIG. 10 is a flow chart of an example of a method of an autonomous interaction between PICOs autonomously representing disparate entities.

FIG. 11 is a functional block diagram of one embodiment of a computer system of one possible PICO in a network of autonomous PICOs for conducting autonomous interactions on behalf of an entity.

### DETAILED DESCRIPTION

This disclosure includes, among other things, various embodiments of systems and methods relating to autonomously establishing terms and paying for services. Persistently available compute objects, or just persistent compute objects (PICOs), may operate autonomously on behalf of their owner. PICOs may communicate with other online services and even pay for services in accordance with one or more rules that the owner or other associated entity has set.

In some embodiments, PICOs may have an identity, storage, an open event network interface, a processor, event channels, and an application program interface (API). For example, a PICO may be a small, special-purpose, online computer. A PICO may be virtualized for scalability. For example, a PICO may be an object (in the object-oriented programming sense) that has persistent storage and is always online.

In other embodiments, PICOs can run inside a container (similar in concept to a Java Web container). The container may provide the underlying environment for PICOs to exist, execute, and communicate. In various embodiments, PICOs can also be implemented as free-standing computational objects.

Each PICO may have a unique identity that represents a person, device, thing, organization, concept, or other identifiable entity. This identity allows the PICO to function as an independent agent and create relationships with other PICOs. In some embodiments, the basic identifier may be called a Kinetic Entity Number or KEN. KENs are chosen so as to be globally unique. The PICO's identity allows it to function as a peer in a network of PICOs and may be used as the basis for its addressability. Because of the unique identity, containers may be multi-tenanted.

PICOs may be persistent in the sense that they exist from when they are created until they are explicitly deleted. Restarting the container, for example, does not change the state of the PICOs for which it is responsible. PICOs may come back online just as they were when the container was stopped. PICOs may be configured to encapsulate data. Encapsulation allows data to be stored persistently and accessed by processes running in the PICO. In some embodiments, the only way for the data to be exposed outside the PICO is for a function to explicitly expose the value. PICOs may store data inside entity variables. That is, each application running in a PICO stores its own set of independent entity variables and values. In some embodiments, data may be shared inside the PICO. For example, applications in a PICO can ask other applications for data via the programming and communications model for the PICO. Entity variables may free PICO programmers from having to worry about databases for common storage needs.

Events that are sent to a PICO may be processed on an open event network. In some embodiments, the default behavior is for every rule in the PICO to see every event and determine, based on its event expression, whether to perform a specified function. The determination may be made based on selected rules run by the container. In some embodiments, a “salience graph” may be used to determine which events are salient for a given event and only return those that might select. The returned events may be evaluated against the rule of the event expression to determine an appropriate selection.

Open event networks may be configured to allow for loose coupling between event senders and the PICO. In particular, open event networks provide one or more of receiver-driven flow control and near real-time propagation.

For example, with respect to receiver-driven flow control, once an event generator sends an event notification, its role in determining what happens to that event is over. Downstream event processors may ignore the event, may handle it as appropriate for their domain, or may propagate it to other processors. A single event can induce multiple downstream activities as it and its effects propagate through the event-processing network. Unlike demand-driven (i.e., request-response) interactions, event notifications do not include specific processing instructions. This reversal of semantic responsibility facilitates loose coupling.

In some embodiments, the event processing systems may work in real-time in contrast with batch-oriented, fixed-schedule architectures. Events propagate through the network of PICOs soon after they happen and can further affect how those PICOS will interpret and react to future events from the same or different event generators. Open event networks thus allow a more natural way to design and create real-time information systems. As more and more information online gains a real-time component, this kind of processing becomes more and more useful.

The PICO processor may facilitate the use of applications. Applications, which may be represented as collections of rulesets in some embodiments, may respond to events and access entity variables. These applications may operate without the owner of the PICO being present. That is, they may operate autonomously. For example, PICOs may run programs in response to their inputs. The results are based on those inputs and the current state as embodied in the entity variables and the context discernible from the APIs. The response might be a JavaScript Object Notation (JSON), other events, or both. In some embodiments, the response can produce side effects by calling other Web APIs.

In various embodiments, the actions may be maintained confidentially from an associated owner or entity. The transactions of a PICO may be considered to be arms-length transactions for legal purposes, and the associated or represented entity or person may be able to legally maintain ignorance of the actions made. This may be helpful in various contexts, such as to avoid insider trading, purchasing, selling, etc. In some embodiments, PICOs of two represented entities may agree to an exchange, sale, purchases, procurement, provision, or other transaction without either of the represented entities being privy to the transaction. That is, the PICOs may explicitly agree that some terms of the transaction will be confidential, even from the transacting parties.

PICOs may communicate with each other via event channels. A PICO can create as many event channels as necessary for its operation. In various embodiments, event channels are one-way, so if two PICOs need to communicate with each other, they both create an event channel and supply it to the other in a process called “symmetric subscription.” Event channels have unique identifiers called “event channel identifiers” (ECIs). Event channels can be independently managed, permissioned, and responded to. In some embodiments, a new event channel is created for each connection rather than having multiple entities communicate over a single channel. In another embodiment, event channels may have attributes and use attribute-based authorization to control inbound communications. PICOs and their event channels may be constructed so that there need be no relationship between the PICO containers (and their hosts or “hosters”) for two PICOs to share a channel.

In some embodiments, a network of PICOs can be hosted in containers run by multiple independent entities. Some of these containers may be self-hosted. These properties allow a collection of PICOs to create a peer-to-peer network regardless of where they are hosted. Various possible global indexing schemes, including some well-known schemes, may be used in connection with the presently described embodiments.

PICOs may support a programming model that allows them to be customized. The programming model might be rules-based depending on the API model. For example, PICO APIs may support an event-query model wherein separate APIs are provided for listening for events and for processing queries. Each of these APIs is more properly called a “meta-API” or metaprotocol since it does not define a specific API, but rather describes the way APIs will be constructed from the particular rulesets installed on a given PICO. For example, the API for a given PICO may depend on the rulesets installed in it. In additional embodiments, rulesets running in a PICO can use HTTP to access any other Web-based APIs, making PICOs powerful integration and application platforms for using the many Web-based APIs available online.

PICOs may operate autonomously, without their owner's direct interaction, so that they can act on behalf of their owner (or other associated entity). PICOs can be given a monetary budget. PICOs can negotiate for services and make payments consistent with that budget and their programming. For example, PICOs may use their components, including, channels, programs, and APIs, to interact with other online services. These interactions can include negotiating a price for those services using a budget set by the owner and rules for negotiating that might be a combination of special-purpose negotiating rules and specific instructions from the owner. In such an example, PICOs may use a payment system to transfer value from their account to the account of the system they are negotiating with. Different systems and methods of payment may be used depending on the context of the payment.

According to various embodiments, a computer-implemented system or method may be described in terms of one or more sub-systems referred to herein as simply “systems” with the understanding that many “systems” may be used together to form a larger system.

The embodiments of the disclosure are described below with reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor do the steps or sequences of steps need to be executed only once or even in the same order in subsequent repetitions.

Embodiments may include various steps, which may be embodied in machine-executable instructions to be executed by a computer system. A computer system includes one or more general-purpose or special-purpose computers (or other electronic devices). The computer system may include hardware components that include specific logic for performing the steps or may include a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell, Microsoft, Artisoft, and other vendors, and may operate using MQTT, TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Each computer system includes one or more processor and/or memory; computer systems may also include various input devices and/or output devices. The processor may include a general purpose device, such as an Intel®, AMD®, or other “off-the-shelf” microprocessor. The processor may include a special purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tapes, CD-ROMs, DVDs, PROMs, RAM, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, class, etc., that perform one or more tasks or implement particular abstract data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the presently described embodiments is already available, such as computing devices, computer programming tools and techniques, computer networks and networking technologies, digital storage media, authentication, access control, and other security tools and techniques provided by public keys, encryption, firewalls, and/or other means.

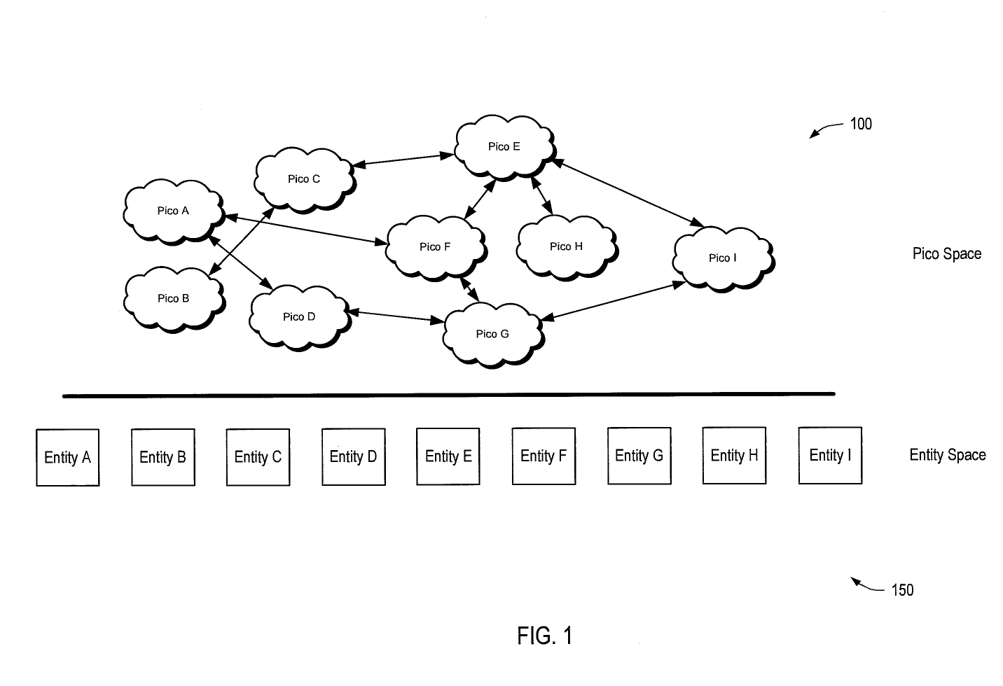

FIG. 1 illustrates a block diagram of a plurality of persistent compute objects (PICOs) 100 that represent a plurality of entities 150, according to one embodiment. And, as shown, each PICO 100 may interact with one or more other PICO 100 devices.

Each PICO 100 is uniquely identifiable and only representative of the entity 150 that owns it. For instance, Entity G is represented by PICO G. If a PICO 100 is sold to another entity 150 the PICO 100 may be set to represent the new entity 150. Each entity 150 may set rules for the PICO 100 representing it.

Each of the PICOs 100 may be portable and autonomous. They may be individual hardware devices and form a peer-to-peer network. In another example, the PICOs 100 may be extracted and may be software modules. Communication between PICOs 100 may be established through existing networks such as the Internet, Wi-Fi, Bluetooth, Zigbee, radio waves, or other suitable communication means.

The networked ecosystem of PICOs may provide for an autonomous electronic representative of consumer product to interact with an autonomous electronic representative of a manufacturer of the consumer product or an autonomous representative of a product repair facility for repairing the consumer product. For example, the entities 150 represented by the PICOs 100 may include a consumer product, a manufacturer, and a repair facility.

In some embodiments, entities 150 can set what data they will allow to be communicated with a certain type of entity 150. For example, Entity F may be a large company trying to advertise its services. In such a case, PICO F may be set to share all relevant data including pricing, availability, and location. Further, PICO F may allow that data to be shared by other PICOs 100. For instance, if PICO F shares its pricing data with PICO E, PICO E may have permission from PICO F to share that data with other PICOs 100 such as PICO I. The owner of PICO E, Entity E, may, however, set rules to not share data it receives from other entities 150. In this manner one PICO 100 may find another PICO 100 from the shared data. In some embodiments, the represented entity 150 may be an inanimate object, in which case the PICO 100 representing the entity 150 may be owned by an entity 150 (person, corporation, organization, etc.) that is different from the represented entity 150.

In another embodiment, the networked ecosystem of PICOs for an autonomous electronic representative of consumer product may interact with an autonomous electronic representative of a manufacturer of the consumer product and an autonomous representative of a product repair facility for repairing the consumer product. The plurality of PICOs may include a first PICO configured to autonomously represent a consumer product within an ecosystem of communicatively coupled PICOs. A second PICO may be configured to autonomously represent a manufacturer within the ecosystem of communicatively coupled PICOs. Further, a third PICO may be configured to autonomously represent a repair facility within the ecosystem of communicatively coupled PICOs.

For example, a consumer product may comprise a communications module capable of indicating that a repair is required to the first PICO, independent of any interaction by an owner entity of the consumer product. The first PICO may be configured to autonomously communicate with the second PICO representing the manufacturer to determine if warranty support is provided for the required repair. The first PICO may receive a responsive communication from the second PICO regarding the available of warranty support for the required repair, independent of any interaction by the manufacturer represented by the second PICO. The first PICO may further autonomously establish terms for warranty-covered repair work to be performed on the consumer product by the repair facility with the second PICO and the third PICO based on (1) the availability of warranty support for the required repair and (2) rules for term establishment for the first PICO set by the owner entity of the consumer product.

The consumer product may be a vehicle, a personal electronic device, a toy, a home appliance, and a residence. The consumer product may be associated with the first PICO by the manufacturer such that the first PICO is preconfigured to communicate with the second PICO at a time of purchase of the consumer product.

In yet another embodiment, a system for an autonomous rule-based procurement of a good or service may be implemented. For example, a first PICO may be configured to represent and autonomously act on behalf of a first entity while a second PICO may be configured to represent and autonomously act on behalf of a second entity. A communications network may be configured to allow the first PICO and the second PICO to communicate with each other, independent of any action by the first and second entities. For instance, the first PICO may be configured to interact with the second PICO on behalf of the first entity to establish terms associated with a procurement of a good or service to be provided by the second entity. Each PICO (1) represents a single entity, (2) has access to persistent data storage, and (3) is configured to autonomously interact with other PICOs to establish terms associated with the procurement and provision of the good or service based on entity-defined rules.

The terms may be different depending on the entities represented. For example, the entities may comprise one of a person, a company, an organization, an appliance, a vehicle, a residence, and a commercial property. The established terms may be associated with the procurement of the good or service comprising at least one of a delivery date, a date for the service to be performed, a price, an interest rate, a payment schedule, a payment method, a discount, an agreement for future purchases, a subscription, and an agreement of confidentiality. Further, the established terms may require that at least one of the PICOs maintain at least one element of the established terms to be confidential from one or both entities.

As an example, the interaction between the first and second PICO may comprise a series of offers and counteroffers. Further, the first PICO may be communicatively coupled to a third PICO associated with a third entity. This may allow the first PICO to solicit and receive information from the third PICO during the interaction with the second PICO that the first PICO can use to establish terms for the procurement of the good or service.

In another embodiment, the first PICO may be communicatively coupled to a third PICO associated with a third entity, and configured to interact with the second PICO and the third PICO concurrently. This may establish terms for the procurement of the good or service from only one of the second entity and the third entity represented by the second PICO and the third PICO, respectively.

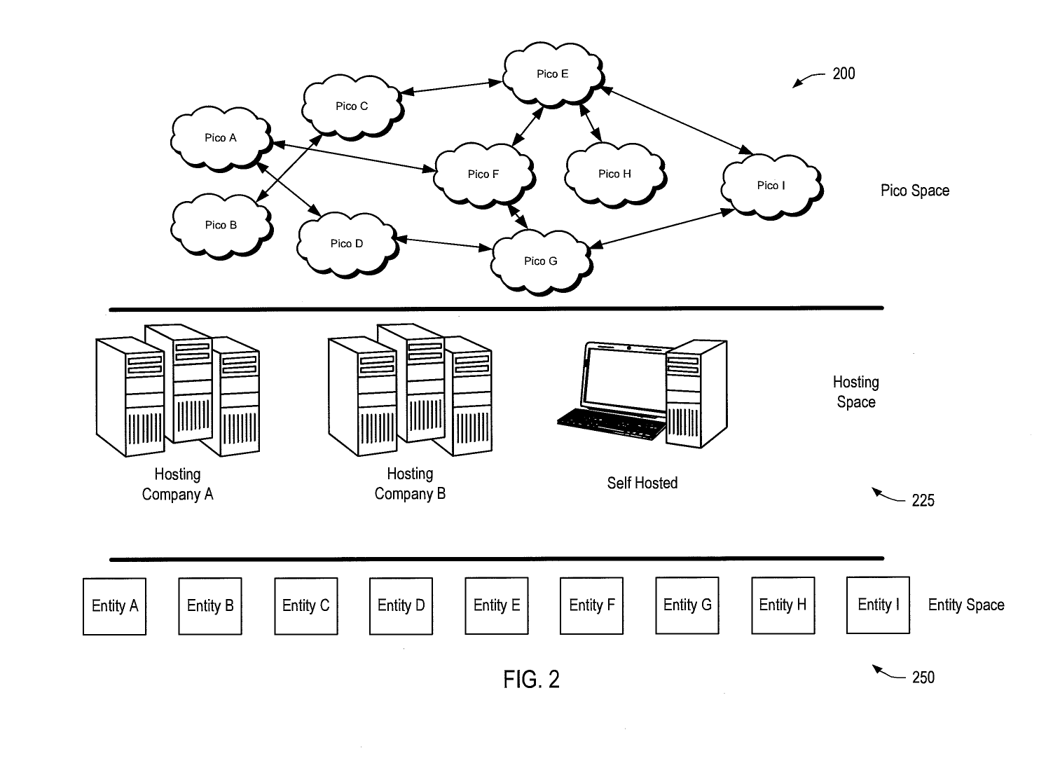

FIG. 2 illustrates a block diagram of a network architecture for a PICO space 200, an entity space 250, and an intermediate hosting space 225 with a variety of optional hosting possibilities, according to various embodiments. Each entity can choose where its PICO is hosted.

Each Pico can be hosted by any hosting company or self-hosted and is entirely portable. The PICO may be completely owned by an individual and not owned or managed by a manufacturer. For example, an entity (person, corporation, organization, etc.) may have several PICOs associated with it or with products it owns. All the PICOs can be connected and act synergistically to eliminate how much input the owner has to provide.

The owner may set the rules for how autonomous the PICOs can be. For example, rules might include interactions with a “budget” PICO that manages the owner's personal finances. The owner's car might need an oil change and lawnmower might need a repair or its blades sharpened. The owner's personal PICO that manages his schedule and budget might determine when the services will take place based on the owner's schedule. In some embodiments, the PICOs may prioritize when each service should get taken care of based on its relative priority and the owner's budget.

For example, PICO G may be owned by Entity G. Entity G may decide to self-host its PICO. This may give Entity G more control and flexibility. As another example, Entity F may decide to allow Hosting Company B to host PICO F. That way Entity F does not have to maintain the hosting server. Each entity has a choice and no matter which hosting method the entity prefers, each PICO is uniquely identifiable and only represents the entity that owns the PICO or represents an object that belongs to the entity that owns the PICO.

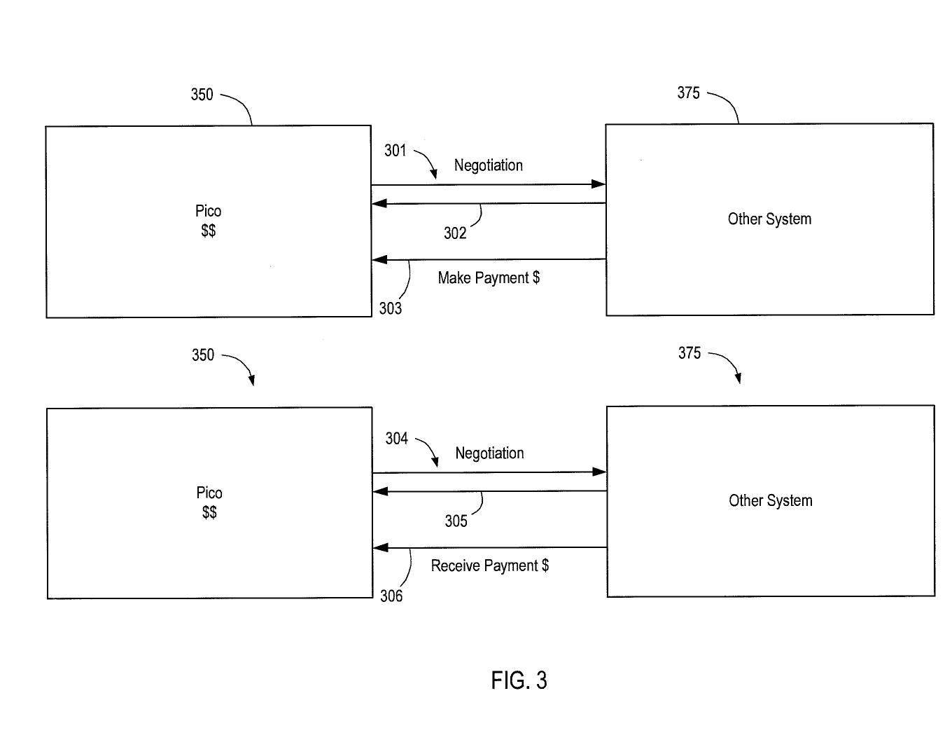

FIG. 3 illustrates an example of entity-represented autonomous negotiation by a first PICO 350 with another system 375, according to one embodiment. The first PICO 350 may negotiate payment for goods/services acting within a set of predefined rules.

The first PICO 350 may have been preconfigured, either by the manufacturer or owner, to know when maintenance is due on the entity represented by the first PICO 350. The first PICO 350 may autonomously initiate an interaction 301, 302, 304, 305 to have this maintenance performed. The other system 375 may counter the offer. In which case the first PICO 350 would have the opportunity to accept or counter again based on a set of rules.

The first PICO 350 may be further configured to established payment terms associated with the procurement of a good or service in addition to the warranty-covered repair work. For example, the first PICO 350 may require the other system 375 to make a payment 303 with a credit card, checking account, or points. After the other system 375 provides a proper payment form, the first PICO 350 may receive a payment 306. The owner of the first PICO 350 would not be required at any step of the transaction.

For example, the owner of the first PICO 350 may establish a set of rules indicating price, availability, payment method, etc. For instance, if the first PICO 350 were attempting to create an appointment for a service, the owner of the first PICO 350 may have set his availability for after a certain time. In another embodiment, the first PICO 350 may receive this availability data autonomously through another PICO representing the owner's calendar. If the other system 375 requests something that is outside the rules, the PICO may reject or counter the proposed offer.

The PICO may be configured to interact with a number of systems. In some embodiments, the other system 375 may be represented by a second PICO. In other embodiments, the other system 375 may be a Website such as an ecommerce site, a manufacturer's Website, or a repair shop's Website.

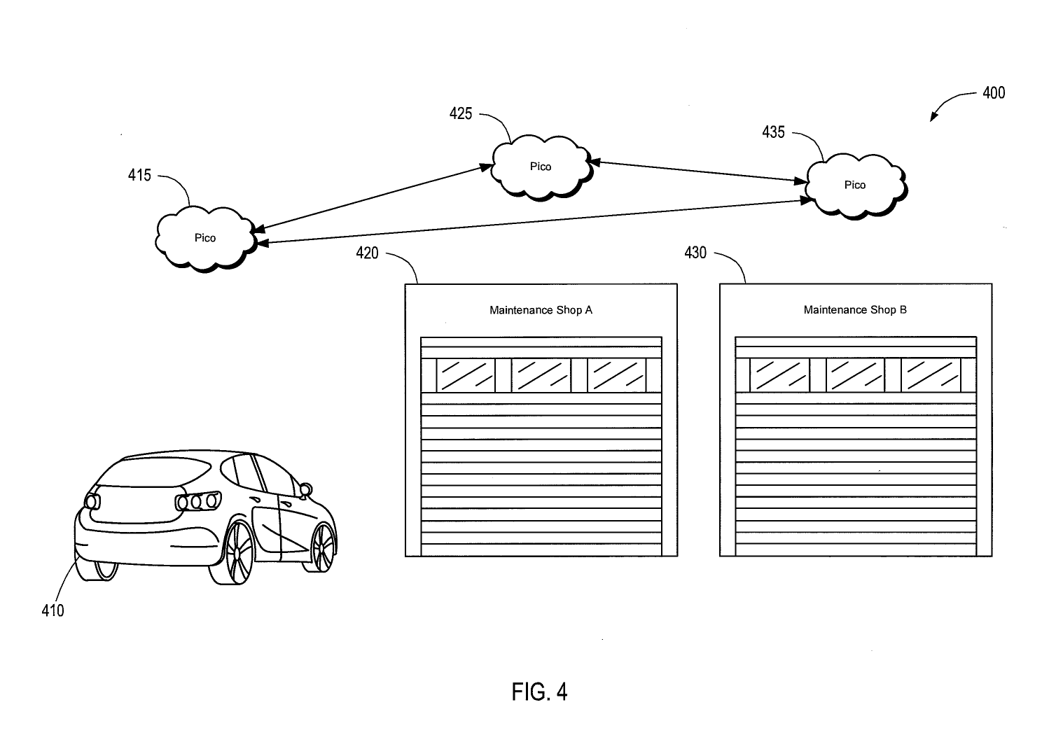

FIG. 4 illustrates an ecosystem 400 in which a PICO 415 autonomously represents a vehicle 410 in communication with PICOs 425, 435 autonomously representing two different maintenance shops 420, 430, according to one embodiment. The PICOs may provide an autonomous transaction for a service required by the vehicle 410.

The PICO 425 representing the vehicle 410 may receive OBD codes. For example, a vehicle can throw codes via OBD port. An OBD plugin may be used to communicate with a PICO in the cloud that will then act on behalf of the car to get necessary service performed by talking to PICOs representing maintenance locations and the owner of the car for scheduling and/or final confirmation/approval. In some embodiments, the PICO 425 can negotiate timing, payment, method of payment, benefits associated with rewards, etc. The rules governing the PICO 425 could include a monthly maintenance budget.

For example, the PICO 415 representing the vehicle 410 may be configured to reach out to maintenance shops in the area for necessary service. The vehicle 410 may notify the PICO 415 of its manufacturer's recommended maintenance. Alternatively, the manufacturer may preload this information onto the PICO 415. Based on this information, the PICO 415 may reach out to several maintenance shops such as maintenance shop A 420 and maintenance shop B 430. The number and location of shops reached out to by the PICO 415 may be determined based on a set of rules governing the PICO 415. The owner of the PICO 415 may establish the rules. For example, an owner may set a rule that the PICO 415 only search for maintenance shops within 10 miles.

In another example, the maintenance request may occur based on an emergency roadside event. The PICO 415 may have a GPS in order to know of nearby shops and reach out to them. The PICO 415 may have a different set of rules governing emergency events. For example, the owner of the vehicle 410 may set a rule allowing a higher price than normal, and another rule to select the shop with the soonest availability.

The maintenance shops may also be represented by PICOs (e.g., PICO 425 and PICO 435). The maintenance shops may have also configured the PICOs representing their shops with a set of rules, for example, what to initially offer a customer, the lowest hourly rate, and the time it takes for certain repairs. PICOs 425 and 435 may respond to the PICO 415's request based on this ruleset. The negotiation may continue or the PICO 415 may accept the terms presented. The PICOs may also be configured to autonomously set a time for the service to take place. The PICOs may know the entities' schedules and pick an available time.

If one maintenance shop's PICO offers a lower rate than the other shop's, the PICO 415 representing the vehicle 410 may use this information to negotiate with the higher priced shop. For example, if the PICO 425 quotes a price $100 cheaper than the PICO 430, the PICO 425 may counter the PICO 430 with a lower price and refer the PICO 430 to the PICO 425. In another embodiment, the PICOs representing the maintenance shops may be in constant communication and their rulesets may be based on information contained in the other PICO. For example, maintenance shop A 420 may set a rule for its PICO 425 to match any sale price set on the PICO 435.

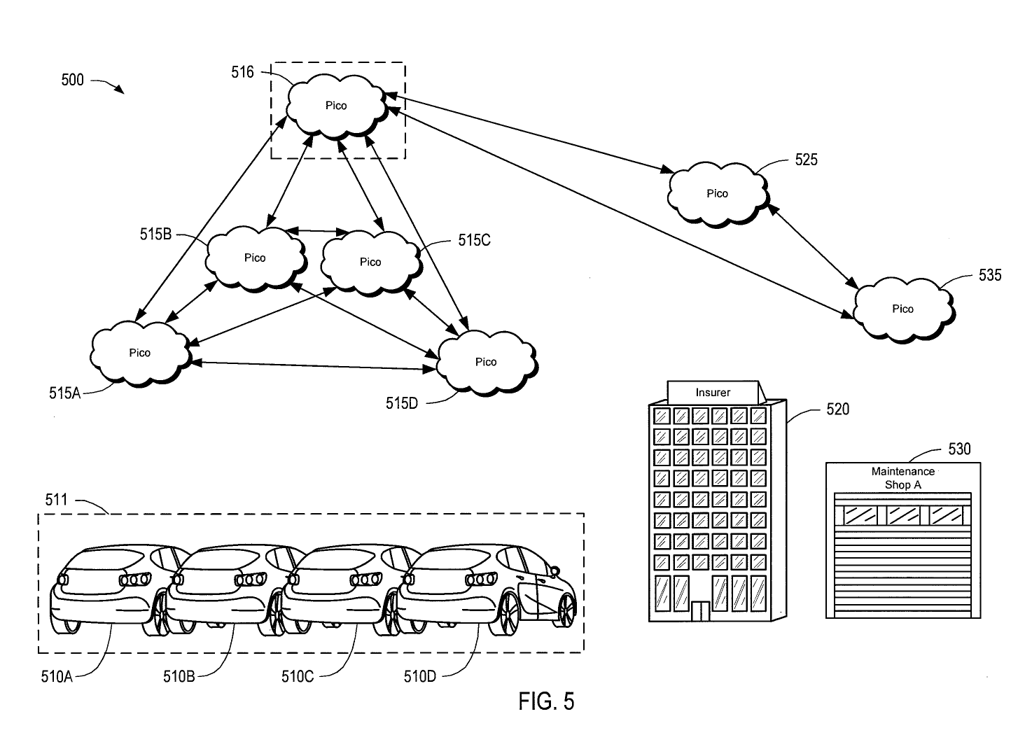

FIG. 5 illustrates an example of an ecosystem 500 in which PICOs 515 represent individual vehicles 510 within a fleet 511 that is in turn represented by a fleet PICO 516, allowing for autonomous fleet-level communications with PICOs (525, 535) representing insurers 520 and maintenance shops 530. The PICOs representing vehicles 510 in the fleet 511 can help each other and indicate needs to a PICO representing the entire fleet 511. The fleet PICO 516 can then negotiate with others to get services/goods in bulk discounts.

The fleet PICO 516 may provide a way to get a bulk discount. For example, the fleet PICO 516 may request a quote for insurance from the insurance PICO 525. The insurance PICO 525 may have a set of rules that allow a 10% reduced fee if the insurance is purchased for four or more cars. Similarly, the maintenance PICO 535 may have a rule set by the owner of the maintenance shop A 530 for 15% off services rendered if the entire fleet 511 is serviced. The fleet PICO 516 may also reach out to the insurance PICO 525 to find approved maintenance shops in the event a vehicle needs service that is approved by the insurance.

PICOs 515 A-D representing the vehicles 510 in the fleet 511 may communicate with each other. For instance, the PICOs 515 A-D may notify each other of services needed for their represented vehicle 510. Each vehicle 510 in the fleet 511 may have different service needs. For example, if a fleet owner wants to set the PICOs 515 A-D to request an oil change from maintenance shop A 530 every 3,000 miles, it is likely the vehicles 510 would need to be taken for service individually. By allowing communication between vehicles 510, the ecosystem 500 provides a solution. For example, in some embodiments, the vehicle 510 in need of service sends a notice out, via its PICO, to the fleet PICO 516 as well as the other PICOs representing vehicles 510. The other PICOs can then communicate with the fleet PICO 516 and the PICO representing the vehicle 510. These PICOs may alert each other of how near they are to needing the same maintenance, and based on its ruleset the fleet PICO 516 may delay the service request or include those nearly needing the service in a request.

The fleet may not be a commercial fleet. It may be a group of individual car owners banding together to get a group discount. For example, the fleet can be a membership of random owners that join the “fleet” for extra discounts.

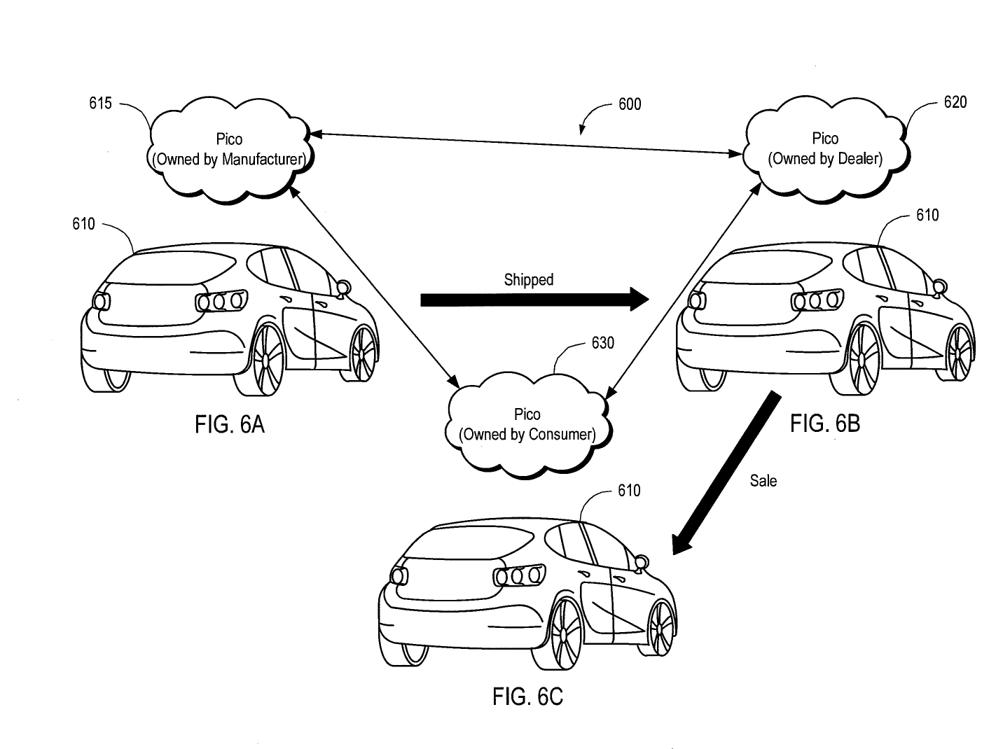

FIGS. 6A-6C illustrate the transition of ownership of an autonomous PICO 600 representing a vehicle 610 from a manufacturer 615 to a dealer 620 and then to a consumer 630.

The ownership and functions of a PICO can change as a product moves through its lifecycle: manufacturer, dealer, and owner. For example, while the manufacturer 615 owns the PICO, the PICO may track the vehicle 610's progress in the manufacturing cycle. While the dealer 620 owns the PICO, the dealer 620 may want the PICO to track test drives. When the consumer 630 purchases the vehicle 610, the PICO may also change ownership and thereafter be associated with the consumer 630. The PICO can have pre-established relationships and can be granted new relationships by each new owner of the PICO.

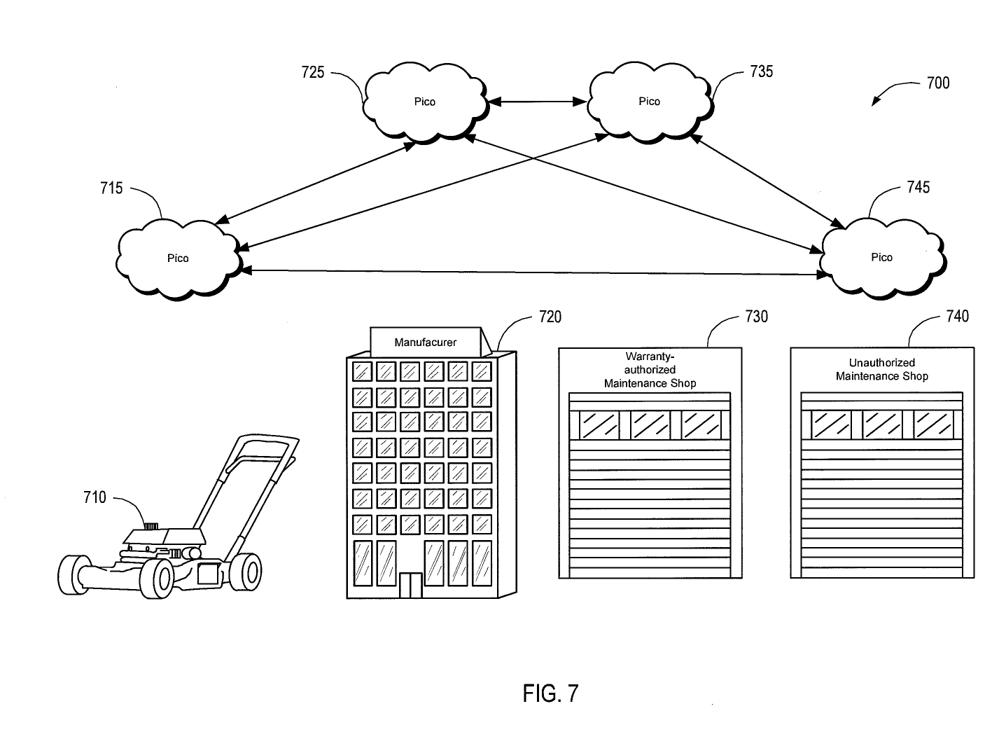

FIG. 7 illustrates a system 700 in which a PICO 715 autonomously represents a lawnmower 710 in communications with PICOs (725, 735, 745) representing a manufacturer 720, a warranty-authorized maintenance shop 730, and an unauthorized maintenance shop 740. As shown, the PICO associated with the consumer product may be configured to receive a communication from the second PICO identifying the third PICO as a PICO that autonomously represents a warranty-authorized repair facility for warranty-covered repair work to be performed on the consumer product.

For example, the PICO 715 representing the lawnmower 710 may autonomously communicate with the second PICO 725 representing the manufacturer 720 to determine if warranty support is provided for a required repair. The PICO 715 may receive a responsive communication from the manufacturer PICO 725 regarding the available of warranty support for the required repair, independent of any interaction by the manufacturer 720 represented by the manufacturer PICO 725.

The manufacturer PICO 725 may also provide a list of warranty-authorized maintenance shops. Based on the received information, the PICO 715 may autonomously establish terms for warranty-covered repair work to be performed on the consumer product. For example, the PICO 715 may set up a repair with the PICO 735 representing the warranty-authorized maintenance shop 730 based on (1) the availability of warranty support for the required repair and (2) rules for term establishment for the first PICO set by the owner entity of the consumer product. The manufacturer PICO 725 may be notified by the warranty-authorized maintenance shop 730 the service has been completed, and an autonomous monetary transaction may occur between the PICOs based on the service rendered.

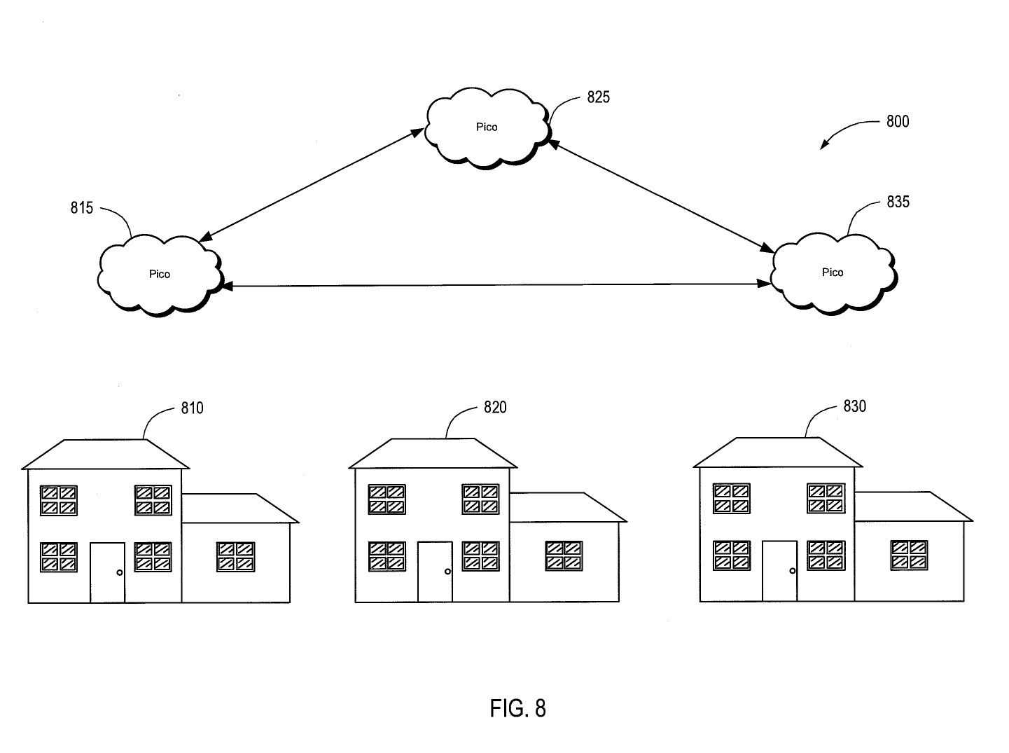

FIG. 8 illustrates a neighborhood 800 in which each neighbor (810, 820, 830) is autonomously represented by a PICO (815, 825, 835), according to one exemplary embodiment. As shown, each neighbor's PICO may communicate with each other. If one neighbor PICO determines it needs a service, the other PICOs may indicate that they also need that service. Thus the neighbors can collectively seek a service in order to receive a bulk discount.

For example, if the PICO 815 determines the neighbor 810 requires pest control, it may indicate that need to the other neighbors. The PICO 825 may then indicate that the neighbor 820 also requires pest control. The PICOs may then seek a pest control company and may receive a bulk discount. For instance, if the pest control company is represented by a PICO, the PICO may have rules indicating that if two houses are close together in proximity they may receive a discount.

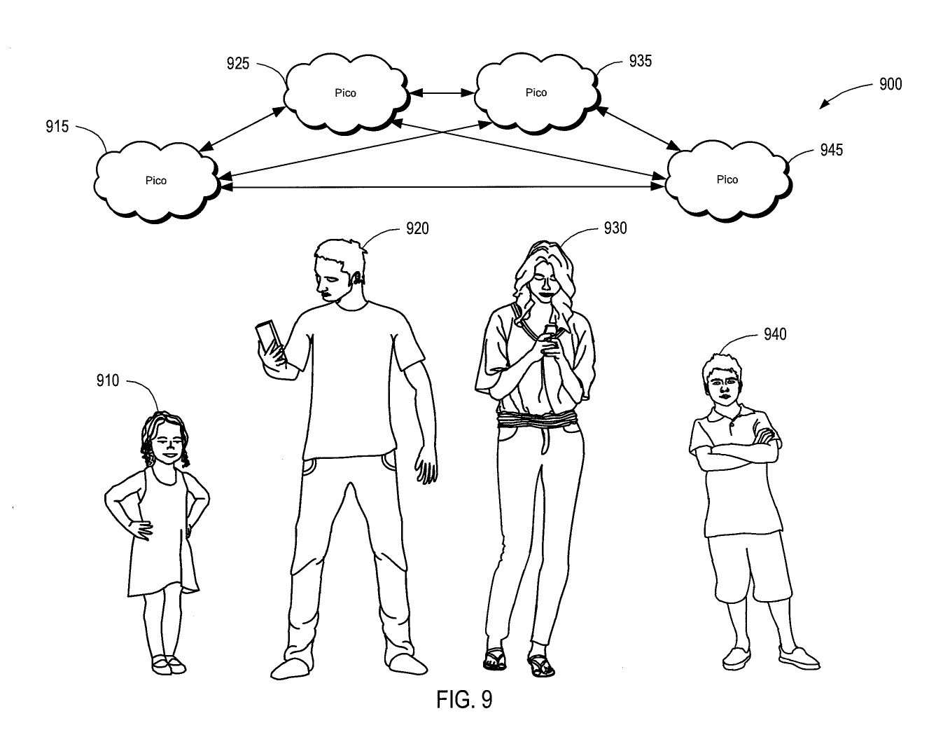

FIG. 9 illustrates a family 900 in which each family member is autonomously represented by a PICO, according to one exemplary embodiment. In this embodiment, a mother 930, father 920, son 940, and daughter 910 may have their schedules autonomously represented and linked together via their PICOs (915, 925, 935, 945). The PICOs may uniquely identify each member of the family 900. This may assist each PICO when autonomously scheduling an event. For example, the father's PICO 925 may be attempting to set an appointment for an oil change. The son's PICO 945 may notify the father's PICO 925 that his baseball game is on Tuesday at 5:30 PM. The father's PICO 925 may then select another time for the oil change.

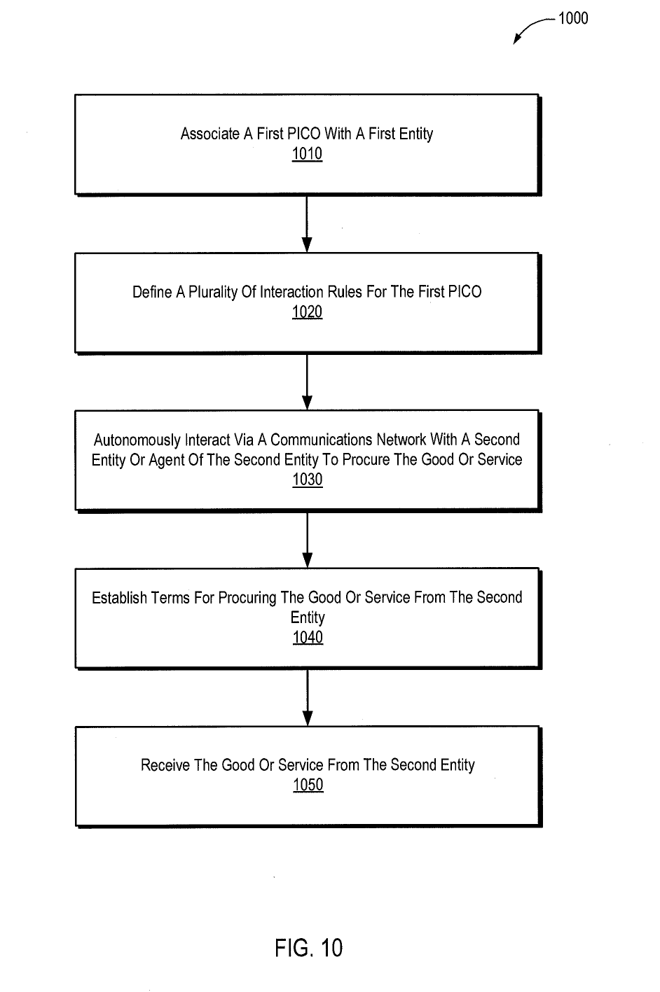

FIG. 10 is a flow chart 1000 of an example of a method of an autonomous interaction between PICOs autonomously representing disparate entities.

The method may associate a first PICO with a first entity 1010. The first entity may define a plurality of interaction rules for the first PICO 1020. These interaction rules may identify a good or service for which the first PICO is configured to procure, define temporal bounds for the procurement of the good or service, define financial bounds for the procurement of the good or service, and authorize the first PICO to autonomously act on behalf of the first entity in a legally binding manner.

The first PICO may autonomously interact via a communications network with a second entity or agent of the second entity to procure the good or service 1030. The procurement of the good or service may be considered an arms-length transaction based on the autonomous interactions of the first PICO independent of any involvement of the first entity. Further, the first PICO may establish terms for procuring the good or service from the second entity 1040 that are agreed to by the second entity or agent of the second entity. For example, the first PICO may establish payment terms for the provision of the good or service by the second entity to the first entity. Finally, the first entity may receive the good or service from the second entity 1050.

In some embodiments, the agent of the second entity may comprise a second PICO configured to autonomously represent the second entity. In such an embodiment, the first PICO may be configured to autonomously interact with the second PICO via an event channel. In another embodiment, the first PICO may be configured to autonomously interact with the second entity or agent of the second entity via an API. For example, the first PICO may be configured to autonomously interact with the second entity through a Website.

In another embodiment, the first PICO may be configured to autonomously interact with the second entity or agent of the second entity via an open event network. The open event network may allow events to be transmitted and received. Events may be evaluated for saliency and acted upon according to defined interaction rules.

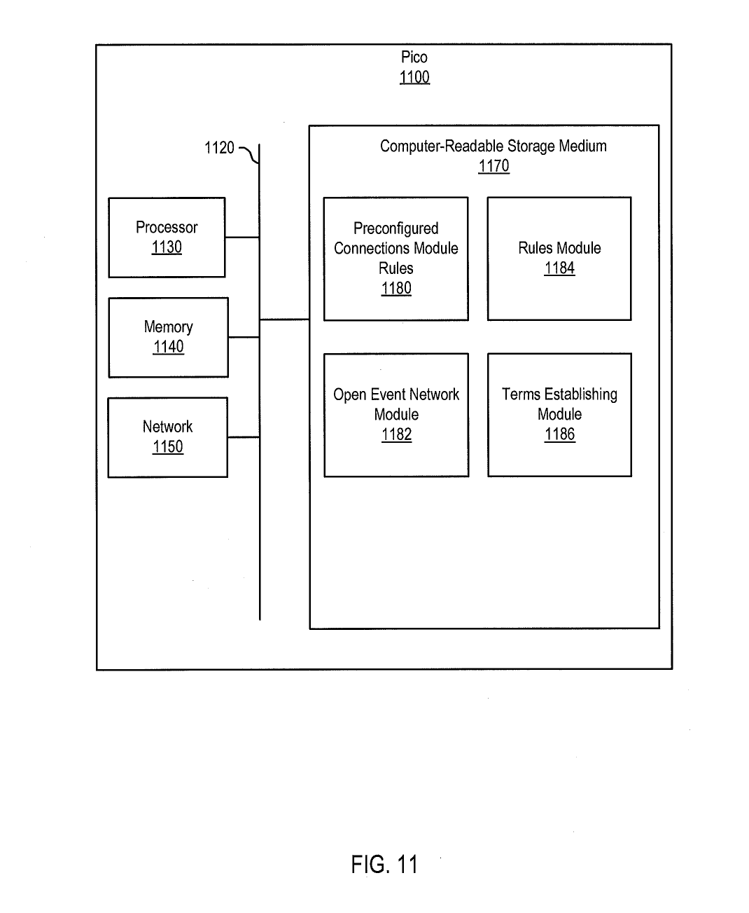

FIG. 11 is a functional block diagram of one embodiment of a computer system of one possible PICO 1100 in a network of autonomous PICOs for conducting autonomous interactions on behalf of an entity. As illustrated, a PICO 1100 may include a processor 1130, a memory 1140, and possibly a network 1150 or other data transfer interface. A bus 1120 may interconnect various integrated and/or discrete components. Various modules 1170 may be implemented in hardware, software, firmware, and/or a combination thereof.

A preconfigured connections module rules 1180 may be configured to receive and store connections at the manufacturer level. For example, the manufacturer may store information about its own PICO on the preconfigured connections module rules 1180 in order to maintain a communication link between the two PICOs.

An open event network module 1182 may be configured to process events sent to the PICO. The open event network module 1182 may receive and send events via an event channel. The open event network module 1182 may order and process received events based on the salience of the information.

A rules module 1184 may be configured to receive rules from the owner. The rules module 184 may have a default set of rules or may require the owner to set rules upon initialization. The rules may be altered. The rules may depend on other PICOs representing the owner's other belongings.

The terms establishing module 1186 may be configured to handle negotiations, interactions, and communications with other systems. The rules module 1184 may provide the rules to the terms establishing module 1186. The rules may be used to manage autonomous negotiations. Other systems may include another PICO or third party API.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

1. A networked ecosystem of persistent compute objects (PICOs) for an autonomous electronic representative of a consumer product to interact with an autonomous electronic representative of a manufacturer of the consumer product and an autonomous electronic representative of a product repair facility for repairing the consumer product, comprising:
a plurality of PICOs, including:
a first PICO configured to autonomously represent a consumer product within an ecosystem of communicatively coupled PICOs;
a second PICO configured to autonomously represent a manufacturer within the ecosystem of communicatively coupled PICOs; and
a third PICO configured to autonomously represent a repair facility within the ecosystem of communicatively coupled PICOs; and
a consumer product comprising a communications module capable of indicating that a repair is required to the first PICO, independent of any interaction by an owner entity of the consumer product;
wherein the first PICO is further configured to:
autonomously communicate with the second PICO representing the manufacturer to determine if warranty support is provided for the required repair,
receive a responsive communication from the second PICO regarding the available of warranty support for the required repair, independent of any interaction by the manufacturer represented by the second PICO, and
autonomously establish terms for warranty-covered repair work to be performed on the consumer product by the repair facility with the second PICO and the third PICO based on (1) the availability of warranty support for the required repair and (2) rules for term establishment for the first PICO set by the owner entity of the consumer product.

2. The networked ecosystem of claim 1, wherein the consumer product comprises at least one of a vehicle, a personal electronic device, a toy, a home appliance, and a residence.

3. The networked ecosystem of claim 1, wherein the first PICO is further configured to receive a communication from the second PICO identifying the third PICO as a PICO that autonomously represents a warranty-authorized repair facility for warranty-covered repair work to be performed on the consumer product.

4. The networked ecosystem of claim 1, wherein the first PICO is further configured to established payment terms associated with the procurement of a good or service in addition to the warranty-covered repair work.

5. The networked ecosystem of claim 1, wherein the consumer product is associated with the first PICO by the manufacturer such that the first PICO is preconfigured to communicate with the second PICO at a time of purchase of the consumer product.

6. A system for an autonomous rule-based procurement of a good or service, comprising:
a first persistent compute object (PICO) configured to represent and autonomously act on behalf of a first entity;
a second PICO configured to represent and autonomously act on behalf of a second entity; and
a communications network configured to allow the first PICO and the second PICO to communicate with each other independent of any action by the first and second entities,
wherein the first PICO is configured to interact with the second PICO on behalf of the first entity to establish terms associated with a procurement of a good or service to be provided by the second entity, and
wherein each PICO (1) represents a single entity, (2) has access to persistent data storage, and (3) is configured to autonomously interact with other PICOs to establish terms associated with the procurement and provision of the good or service-based on entity-defined rules.

7. The system of claim 6, wherein the first entity comprises one of a person, a company, an organization, an appliance, a vehicle, a residence, and a commercial property.

8. The system of claim 6, wherein the established terms associated with the procurement of the good or service comprise at least one of a delivery date, a date for the service to be performed, a price, an interest rate, a payment schedule, a payment method, a discount, an agreement for future purchases, a subscription, and an agreement of confidentiality.

9. They system of claim 6, wherein the established terms require that at least one of the PICOs maintain at least one element of the established terms to be confidential from one or both entities.

10. They system of claim 6, wherein the interaction between the first and second PICO comprises a series of offers and counteroffers.

11. They system of claim 6, wherein the first PICO is communicatively coupled to a third PICO associated with a third entity, and wherein the first PICO solicits and receives information from the third PICO during the interaction with the second PICO that the first PICO can use to establish terms for the procurement of the good or service.

12. The system of claim 6, wherein the first PICO is communicatively coupled to a third PICO associated with a third entity, and wherein the first PICO is configured to interact with the second PICO and the third PICO concurrently and establish terms for the procurement of the good or service from only one of the second entity and the third entity represented by the second PICO and the third PICO, respectively.

13. A method for an autonomous establishment of terms for procuring a good or service, comprising:
associating a first persistent compute object (PICO) with a first entity;
defining, by the first entity, a plurality of interaction rules for the first PICO, wherein the plurality of interaction rules
(1) identify a good or service for which the first PICO is configured to procure,
(2) define temporal bounds for the procurement of the good or service, define financial bounds for the procurement of the good or service, and
(3) authorize the first PICO to autonomously act on behalf of the first entity in a legally binding manner;
the first PICO autonomously interacting via a communications network with a second entity or agent of the second entity to procure the good or service;
the first PICO establishing terms for procuring the good or service from the second entity that are agreed to by the second entity or agent of the second entity; and
the first entity receiving the good or service from the second entity.

14. The method of claim 13, wherein the procurement of the good or service is considered an arms-length transaction based on the autonomous interactions of the first PICO independent of any involvement of the first entity.

15. The method of claim 13, further comprising:
the first PICO establishing payment terms for the provision of the good or service by the second entity to the first entity.

16. The method of claim 13, wherein the agent of the second entity comprises a second PICO configured to autonomously represent the second entity.

17. The method of claim 16, wherein the first PICO is configured to autonomously interact with the second PICO via an event channel.

18. The method of claim 13, wherein the first PICO is configured to autonomously interact with the second entity or agent of the second entity via an API.

19. The method of claim 13, wherein the first PICO is configured to autonomously interact with the second entity through a Website.

20. The method of claim 13, wherein the first PICO is configured to autonomously interact with the second entity or agent of the second entity via an open event network through which transmitted and received events are evaluated for saliency and acted upon according to defined interaction rules.
